(19) United States
(12) Patent Application Publication
(10) Pub. No.: US 2014/0146846 A1
(43) Pub. Date: May 29, 2014

(54) DETECTING SYSTEM AND METHOD FOR DETECTING FAN FAILURE

(71) Applicant: HON HAI PRECISION INDUSTRY CO., LTD., New Taipei (TW)

(72) Inventors: CHIH-CHUNG SHIH, New Taipei (TW); CHAO-KE WEI, New Taipei (TW); HUNG-CHOU CHAN, New Taipei (TW); CHIA-WEN LEE, New Taipei (TW)

(73) Assignee: HON HAI PRECISION INDUSTRY CO., LTD., New Taipei (TW)

(21) Appl. No.: 13/848,684

(22) Filed: Mar. 21, 2013

(30) Foreign Application Priority Data
Nov. 28, 2012 (TW) 101144415

(51) Int. Cl. G01N 25/72

(52) U.S. Cl. CPC G01N 25/72
USPC 374/11

(57) ABSTRACT

A detecting method for detecting fan failure in an electronic device is provided. The electronic device includes at least one fan and an air inlet structure. A first sensor is mounted on a central processing unit (CPU) and senses a first temperature value. A second sensor is mounted on the air inlet structure and senses a second temperature value. The detecting method includes steps of acquiring the first temperature value and the second temperature value; calculating a power value of the CPU; calculating a thermal resistance value based on the acquired first temperature value, the acquired second temperature value and the power value of the CPU; determining whether the calculated thermal resistance value is more than a predetermined thermal resistance value; and generating fan failure information when the calculated thermal resistance value is more than a predetermined thermal resistance value.

### BACKGROUND

1. Technical Field

The present disclosure relates to detecting systems and, particularly, to a detecting system and method for detecting fan failure.

2. Description of Related Art

Cabinets is usually used to place a number of servers and a number of fans. The fans disperse heat generated by the number of servers being run in the cabinet. In order to detect fan failure, a cable is connected between each fan and each server and is detected whether it is in a short circuit state to determine whether the fan is in trouble. However, when the number of the fan and the server is large, it is time-consuming and inconvenient for user to detect every cable to determine whether the fan is in trouble.

Therefore, what is needed is a detecting system and method for detecting fan failure to overcome the above described limitations.

### BRIEF DESCRIPTION OF THE DRAWINGS

FIG. 1 is a block diagram of the hardware infrastructure of a detecting system for detecting fan failure in accordance with an exemplary embodiment.

FIG. 2 is a flowchart of a detecting method for detecting fan failure implemented by the detecting system of FIG. 1, in accordance with an exemplary embodiment.

### DETAILED DESCRIPTION

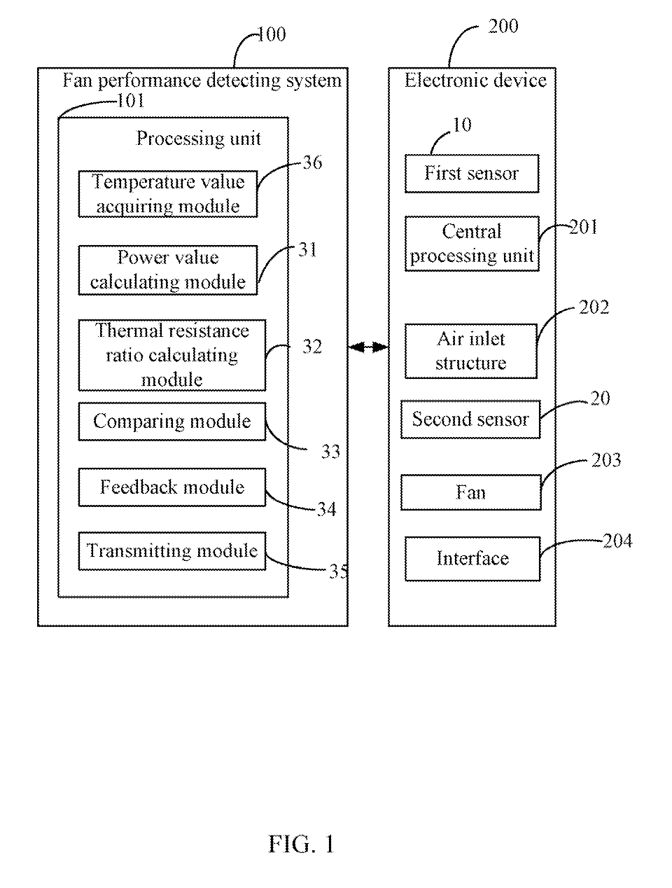

Referring to FIG. 1, a detecting system 100 for detecting fan failure is provided. The detecting system 100 is being applied in an electronic device 200 and includes at least one fan 203 and an air inlet structure 202. The fan 203 dissipates heat generated by a number of components being run within the electronic device 200 via the air inlet structure 202. In one embodiment, the electronic device 200 may be cabinets, computers, mobile devices, for example.

A first sensor 10 is mounted on a central processing unit (CPU) 201, and a second sensor 20 is mounted on the air inlet structure 202. The first sensor 10 senses a first temperature value on the CPU 201. The second sensor 20 senses a second temperature value on the air inlet structure 202.

The detecting system 100 further includes at least one processor 101. The processor 101 includes a temperature value acquiring module 36, a power value calculating module 31, a thermal resistance value calculating module 32, a comparing module 33, and a feedback module 34. The temperature value acquiring module 36 acquires a first temperature value and a second temperature value in real time. The power calculating module 36 calculates a power value of the CPU 201 in real time. In one embodiment, the power calculating module 36 multiplies a current value by a voltage value on the CPU 201 to calculate the power value of the CPU 201 in real time. The thermal resistance value calculating module 32 calculates a thermal resistance value based on the acquired first temperature value, the acquired second temperature value and the power value of the CPU 201. In one embodiment, the thermal resistance value calculating module 32 calculates a difference between the first temperature value and the second temperature value, and calculates a ratio between the difference and the power value of the CPU 201 as the thermal resistance value. The comparing module 33 determines whether the calculated thermal resistance value is more than a predetermined thermal resistance value. The feedback module 34 generates fan failure information when the calculated thermal resistance value is more than the predetermined thermal resistance value. When the feedback module 34 does not generate any information, it means that the fan within the electronic device 200 runs in a normal state, that is, the electronic device 200 normally disperses heat.

Furthermore, the electronic device 200 further includes at least one interface 204 which connects the electronic device 200 to an external monitor device (not labeled) by a data cable. The processor further includes a transmitting module 35. The transmitting module 35 transmits the fan failure information to the external monitor device, thereby providing convenience for user to monitor whether the fan within the electronic device 200 runs in the normal state.

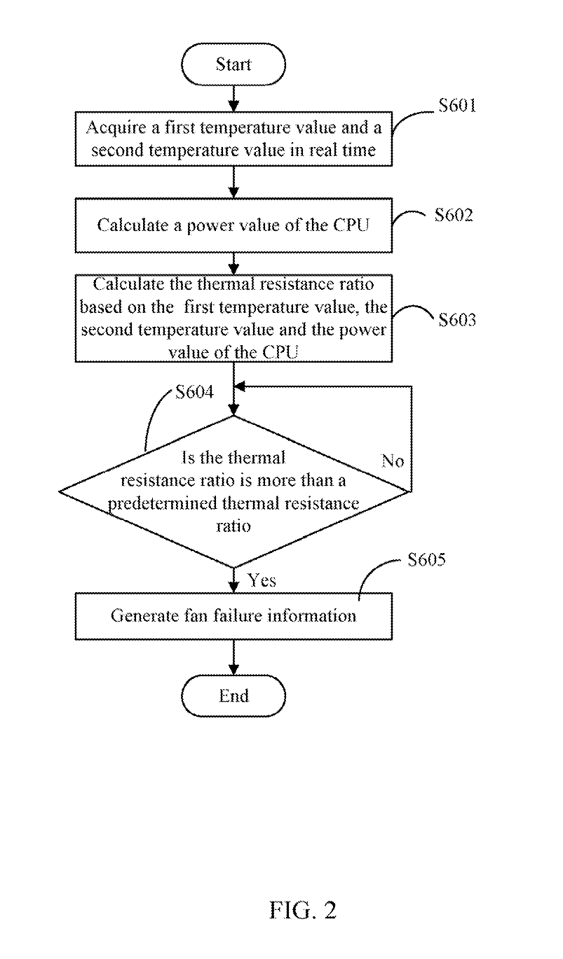

FIG. 2 is a flowchart of a detecting method for detecting fan failure implemented by the detecting system of FIG. 1, in accordance with an exemplary embodiment.

In step S601, the temperature value acquiring module 36 acquires the first temperature value and the second temperature value in real time.

In step S602, the power value calculating module 31 calculates the power value of the CPU 201 in real time.

In step S603, the thermal resistance value calculating module 32 calculates the thermal resistance value based on the acquired first temperature value, the acquired second temperature value and the power value of the CPU 201.

In step S604, the comparing module 33 determines whether the calculated thermal resistance value is more than a predetermined thermal resistance value, if yes, the procedure goes to step S605, if no, the procedure goes to step S601.

In step S605, the feedback module 34 generates fan failure information.

The detecting method further includes a sub step: the transmitting module 35 transmits the fan failure information to the external monitor device which is connected to the electronic device 200.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A detecting system for detecting fan failure in an electronic device, wherein the electronic device comprises at least one fan and an air inlet structure, the at least one fan is configured to disperse heat generated by a plurality of components being run in the electronic device via the air inlet structure, a first sensor is mounted on a central processing unit (CPU) and is configured to sense a first temperature value on the CPU, a second sensor is mounted on the air inlet structure and is configured to sense a second temperature value on the air inlet structure, the detecting system comprising:
at least one processor; and
a plurality of modules to be executed by the at least one processor, wherein the plurality of modules comprises:
a temperature value acquiring module configured to acquire the first temperature value and the second temperature value in real time;
a power value calculating module configured to calculate a power value of the CPU in real time;
a thermal resistance value calculating module configured to calculate a thermal resistance value based on the acquired first temperature value, the acquired second temperature value and the power value of the CPU;
a comparing module configured to determine whether the calculated thermal resistance value is more than a predetermined thermal resistance value; and
a feedback module configured to generate fan failure information when the calculated thermal resistance value is more than a predetermined thermal resistance value.

2. The detecting system for detecting fan failure as described in claim 1, wherein the plurality of modules further comprises a transmitting module which is configured to transmit the fan failure information to an external monitor device which is connected to the electronic device.

3. The detecting system for detecting fan failure as described in claim 1, wherein the thermal resistance value calculating module is further configured to calculate a difference between the first temperature value and the second temperature value, and calculate a ratio between the difference and the power value of the CPU as the thermal resistance value.

4. The detecting system for detecting fan failure as described in claim 1, wherein the power calculating module is further configured to multiply a current value by a voltage value on the CPU to calculate the power value of the CPU in real time.

5. A detecting method for detecting fan failure in an electronic device, wherein the electronic device comprises at least one fan and an air inlet structure, the at least one fan is configured to disperse heat generated by a plurality of components being run in the electronic device via the air inlet structure, a first sensor is mounted on a central processing unit (CPU) and is configured to sense a first temperature value on the CPU, a second sensor is mounted on the air inlet structure and is configured to sense a second temperature value on the air inlet structure, the detecting method comprising:
acquiring the first temperature value and the second temperature value in real time;
calculating a power value of the CPU in real time;
calculating a thermal resistance value based on the acquired first temperature value, the acquired second temperature value and the power value of the CPU;
determining whether the calculated thermal resistance value is more than a predetermined thermal resistance value; and
generating fan failure information when the calculated thermal resistance value is more than a predetermined thermal resistance value.

6. The detecting method for detecting fan failure as described in claim 5, further comprising:
transmitting the fan failure information to an external monitor device which is connected to the electronic device.

7. The detecting method for detecting fan failure as described in claim 5, further comprising:
calculating a difference between the first temperature value and the second temperature value; and
calculating a ratio between the difference and the power value of the CPU as the thermal resistance value.

8. The detecting method for detecting fan failure as described in claim 5, further comprising:
multiplying a current value by a voltage value on the CPU to calculate the power value of the CPU in real time.
